(19) United States
(12) Patent Application Publication
(10) Pub. No.: US 2005/0039981 A1
(43) Pub. Date: Feb. 24, 2005

(54) Evacuation device with releasing handles

(76) Inventors: Peter C. Wooster, Scottsdale, AZ (US); Joseph 'Pepe' Elijio Velasquez, Scottsdale, AZ (US); Daniel Reed, Mesa, AZ (US); Kenneth L. Blue, Scottsdale, AZ (US); Robert Van Arlen Smith, Scottsdale, AZ (US)

Correspondence Address: ROBERT A. PARSONS, 340 E. PALM LN, SUITE 260, PHOENIX, AZ, 85004, US

(21) Appl. No.: 10/644,313

(22) Filed: Aug. 20, 2003

(51) Int. Cl. A62B 1/06

(52) U.S. Cl. 182/75

(57) ABSTRACT

An emergency evacuation device includes a housing enclosing a mounting structure. A spool assembly is mounted on the mounting structure within the housing, the spool assembly includes a rotatably mounted spool designed to receive a length of high tensile strength line. First and second centrifugal brakes are coupled to opposite sides of the spool for rotation with the spool and are constructed to maintain a rotation speed of the spool at a predetermined speed. A pair of spring biased locking pins are positioned adjacent opposite sides of the spool, each having a spool locking position and a spool unlocked position. A pair of handles is positioned to engage the locking pins and move them into the locking position when the handles are moved into a collapsed orientation and to disengage the locking pins when the handles are moved into an extended orientation.

### FIELD OF THE INVENTION

This invention relates to devices for facilitating lowering individuals from elevated positions.

More particularly, the present invention relates to emergency evacuation devices with improved operation.

### BACKGROUND OF THE INVENTION

Providing exits from buildings and other structures is a major concern during planning and construction, particularly in multi-story buildings. Typically, elevators and stairways are employed. For added safety during crisis, shorter multi-story buildings employs fire escapes which are essentially stairways erected on the outside of a building. Escaping buildings has always been a concern during crisis. Elevators are often disabled, and stairways can be blocked, crowded or otherwise made impassable. Fire escapes are very expensive, and typically cannot be used on very tall buildings.

Many diverse device have been developed for evacuating buildings, such as ladders, foldable ladders, escape tubes, climbing ropes, etc, but each has the drawback of being expensive, difficult to use, and un-usable on buildings having great height. Often, evacuation devices require physical strength and specialized skills for use or an individual who is physically fit and skilled to assist. These requirements are often difficult to meet quickly in a crisis situation. On very tall buildings, often referred to as sky scrapers, inner stairways, or aerial evacuation from the roof are generally the only options.

As early as the late eighteen hundreds (see U.S. Pat. No. 287,940 to Johnson, 1883) people have attempted to design devices for lowering people, individually, from tall structures by means of a cable or rope. In general, all of these devices include a supply of cable or rope wound on a drum or reel with a free end attachable to some fixed anchor. The person then can simply exit through a window or off the roof and descend to the ground or a lower story. The major problem is that most of these devices include controls that must be operated by the person descending. It is well known that in emergency situations, such as fires, earthquakes, etc. people have a strong tendency to panic and may not have full control of their faculties. In some prior art devices attempts have been made to include automatic braking or self-braking but these devices are generally complicated and subject to failure. Also, the person descending has a strong tendency to hold or grasp the cable or rope as they descend, which can seriously damage the person's hands and may even disrupt the descent.

It would be highly advantageous, therefore, to remedy the foregoing and other deficiencies inherent in the prior art.

Accordingly, it is an object of the present invention to provide a new and improved emergency evacuation device with lock releasing handles.

Another object of the invention is to provide an emergency evacuation device with lock releasing handles which can be used in all structures of any height and from any floor or level.

And another object of the invention is to provide an emergency evacuation device with handles which is simple to use.

Still another object of the present invention is to provide an emergency evacuation device with lock releasing handles that is compact and lightweight and which is safe to use.

Yet another object of the invention is to provide an emergency evacuation device with lock releasing handles that requires little or no operation by the individual and which does not require physical strength or specialized skills.

### SUMMARY OF THE INVENTION

Briefly, to achieve the desired objects of the instant invention in accordance with a preferred embodiment thereof, provided is an emergency evacuation device for lowering an individual during emergency situations. The device includes a housing enclosing a mounting structure with a spool assembly mounted on the mounting structure within the housing. The spool assembly includes a rotatably mounted spool designed to receive a length of high tensile strength line. A centrifugal brake is coupled to the spool for rotation with the spool. A locking device is carried by the housing and moveable between a spool locking position wherein the locking device engages the spool and a spool unlocking position. Two-hand releasing handle apparatus is positioned adjacent the locking device and mounted so as to selectively provide movement of the locking device into one of the spool locking position and the spool unlocking position.

In a specific aspect, a first centrifugal brake is coupled to the spool at one side of the spool for rotation with the spool and a second centrifugal brake is coupled to the spool at an opposite side of the spool for rotation with the spool. The locking device includes One or more locking pins positioned adjacent a side of the spool, each locking pin having a spool locking position in which the spool is prevented from rotating and a spool unlocked position in which the spool is free to rotate. Two-hand releasing handle apparatus is positioned adjacent the locking pins and mounted so as to selectively provide movement of the locking pins into one of the spool locking and the spool unlocking positions.

In yet a more specific aspect of the present invention the evacuation device includes a housing enclosing a mounting structure with a spool assembly mounted on the mounting structure within the housing. The spool assembly includes a rotatably mounted spool designed to receive a length of high tensile strength line. A first centrifugal brake is coupled to the spool at one side of the spool for rotation with the spool and constructed to maintain a rotation speed of the spool at a predetermined speed and a second centrifugal brake is coupled to the spool at an opposite side of the spool for rotation with the spool and constructed to maintain the rotation speed of the spool at the predetermined speed. A pair of locking pins, one each, is positioned adjacent opposite sides of the spool and each has a spool locking position in which the spool is prevented from rotating and a spool unlocked position in which the spool is free to rotate. Each of the pair of locking pins is spring biased into the unlocked position. A pair of opposed handles is rotatably mounted for movement into one of a collapsed orientation and an extended orientation. The pair of opposed handles is positioned to engage the pair of locking pins and move the pair of locking pins into the locking position when the pair of opposed handles is moved into the collapsed orientation and further positioned to disengage the pair of locking pins when the pair of opposed handles is moved into the extended orientation.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a perspective view of a dual brake emergency evacuation device according to the present invention;

FIG. 2 is a perspective view of the dual brake emergency evacuation device with lock releasing handles in a descending position;

FIG. 3 is a perspective view of the dual brake emergency evacuation device of FIG. 1 with an attached harness and line;

FIG. 4 is a perspective view of the dual brake emergency evacuation device of FIG. 1, with housing removed to better display the inner components;

FIG. 5 is an exploded view of the dual brake emergency evacuation device of FIG. 1 illustrating the major components;

FIG. 6 is an exploded perspective view of the line spool;

FIG. 7 is an enlarged perspective view of the line spool assembled;

FIG. 8 is an exploded perspective view of one of the centrifugal brake assemblies of the dual brake emergency evacuation device of FIG. 1; and

FIG. 9 is a perspective view of the one centrifugal brake assembled.

### DETAILED DESCRIPTION OF THE PREFERRED EMBODIMENT

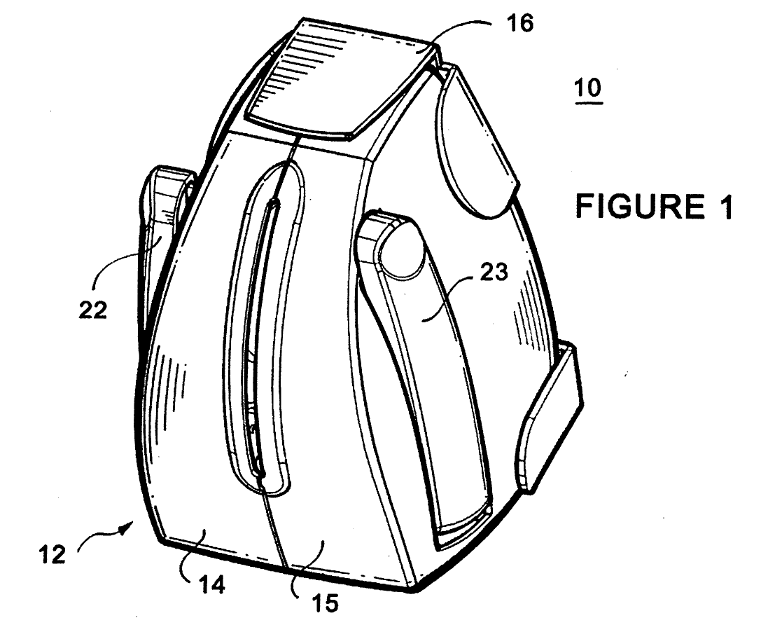

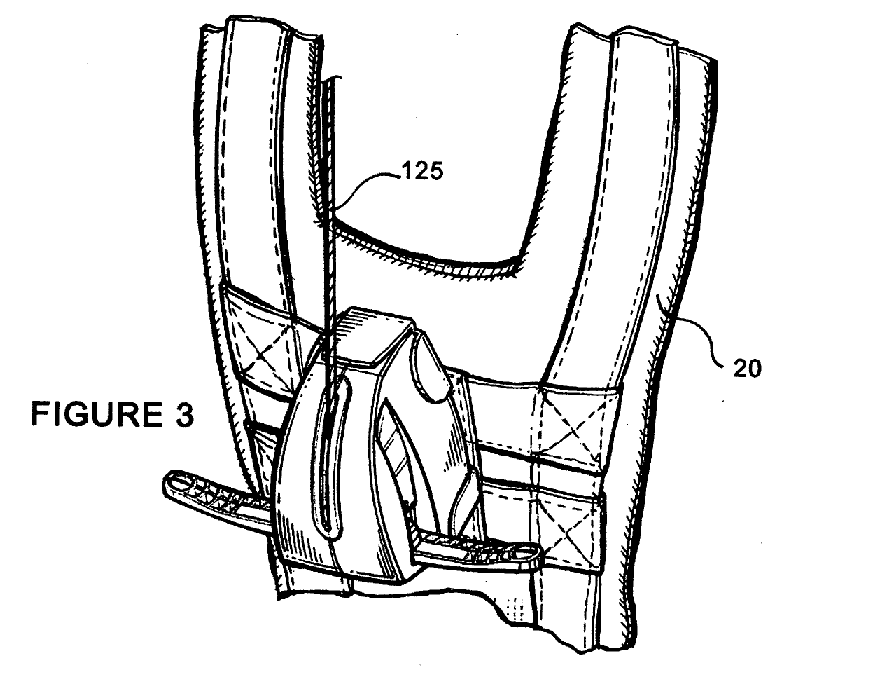

Turning now to the drawings in which like reference characters indicate corresponding elements throughout the several views, attention is first directed to FIG. 1 which illustrates a dual brake emergency evacuation device 10 in accordance with the present invention. Evacuation device 10 includes a housing 12 composed of two clam-shell-like halves 14 and 15. A clip 16 is engaged over housing 12, in the assembled or closed position, and serves to hold housing 12 together and to affix it to a harness 20, illustrated in FIG. 3. Harness 20 can be any device that conveniently and comfortably attaches evacuation device 10 to a person needing to be evacuated. Since harnesses of this type are well known, harness 12 will not be discussed further.

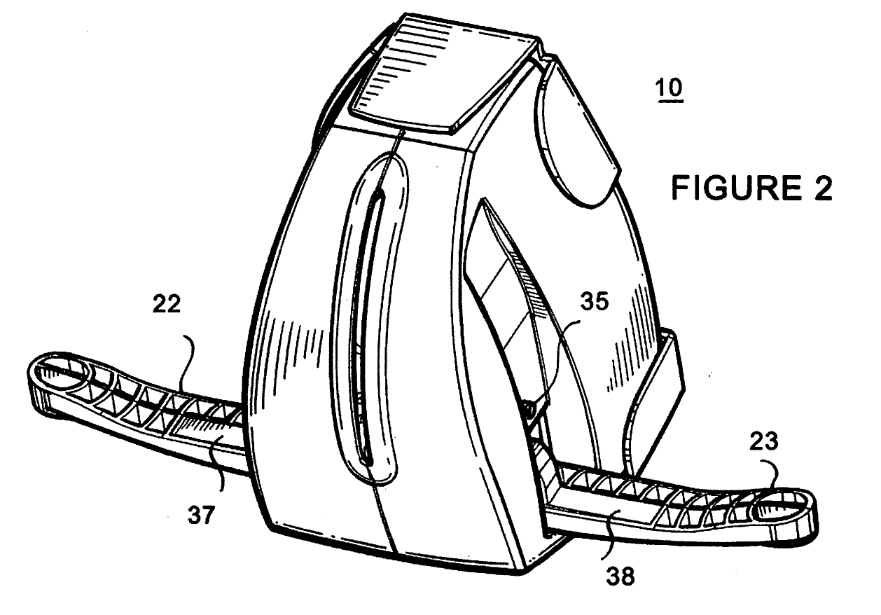

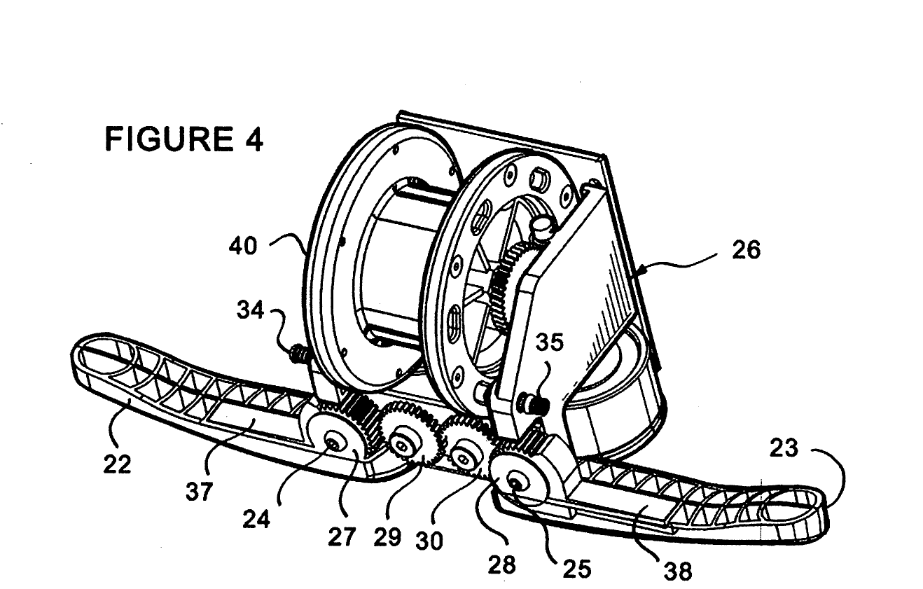

Evacuation device 10 also includes a pair of handles 22 and 24 illustrated in a collapsed or braking orientation in FIG. 1 and in an extended or operative orientation in FIG. 2. Referring additionally to FIG. 4, it can be seen that each handle 22 and 23 is pivotally attached by pivot pins 24 and 25, respectively, at the inner end to a mounting structure 26 for movement between the collapsed and extended orientations. Also, each handle 22 and 23 has a circular gear 27 and 28, respectively, attached for rotation about pivot pins 24 and 25 with the associated handle. Gears 27 and 28 are coupled together by gears 29 and 30 for common rotary movements. Thus, if either handle 22 or 23 is moved from one orientation (collapsed or extended), the other handle 23 or 22 moves with it. While a specific gear arrangement is illustrated in this embodiment, it will be understood that a variety of gearing arrangements can be devised to perform the stated function (e.g. one gear instead of gears 29 and 30, or the direct meshing of gears 27 and 28).

In addition to placing handles 22 and 23 into a position for storing evacuation device 10 when the handles are rotated into the collapsed orientation, handles 22 and 23 each engage a spring loaded locking pin 34 and 35, respectively. Locking pins 34 and 35 are mounted in opposed sides of mounting structure 26 for horizontal movement between an unlocked position and a locked position. Springs associated with the pins in a well known manner bias the pins normally outwardly from the opposed sides of mounting structure 26 when handles 22 and 23 are in the extended orientation illustrated in FIGS. 2 and 4. When handles 22 and 23 are moved into the collapsed orientation (illustrated in FIG. 1), flat surfaces 37 and 38 on the underside of handles 22 and 23, respectively, engage locking pins 34 and 35 and move them horizontally inwardly into locking engagement with a spool assembly 40. As will be explained in more detail presently, spool assembly 40 has holes in opposed sides that locking pins 34 and 35 enter to lock the spool of spool assembly 40 and prevent rotation thereof. While locking pins are employed in the preferred embodiment, it will be understood that other locking or securing devices can be employed. For example, spool assembly 40 can have solid sides (without holes) and act as a disk in a disk brake system actuated by handles 22 and 23. In this example, handles 22 and 23 would cause friction pads on the ends of locking pins 34 and 35 to engage spool assembly 40, inhibiting or preventing rotation with the handles in the stored position. Thus, the term locking device is intended to include pins which are received in holes or which otherwise engage the spool to prevent or inhibit rotation thereof.

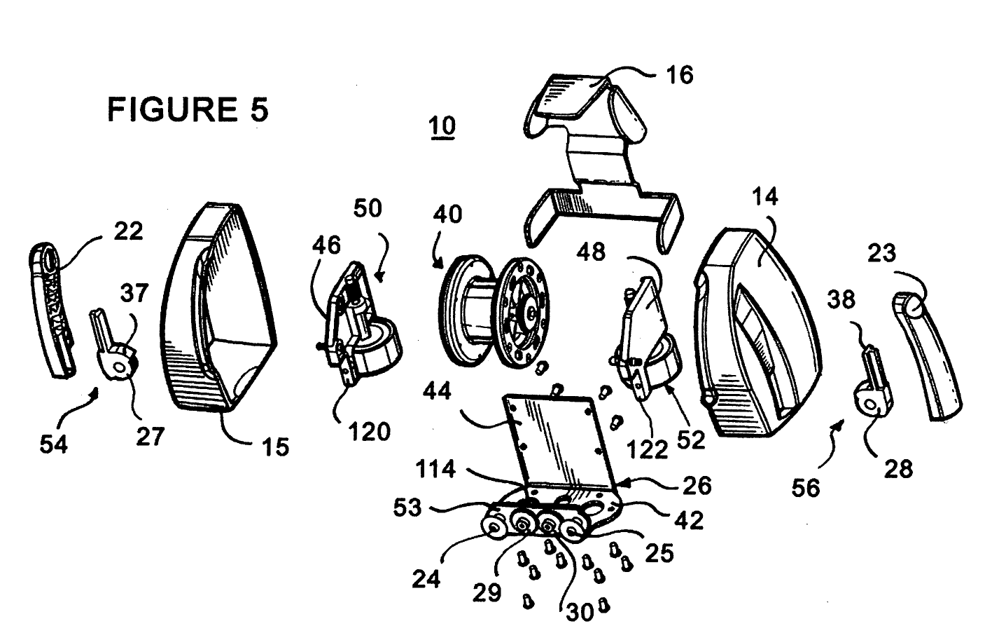

Referring to FIG. 5, an exploded view of dual brake evacuation device 10 illustrates the major components and their associated positions. Referring to both FIGS. 4 and 5 it can be seen that mounting structure 26 includes a base wall 42, an integrally attached wall 44 and opposed side walls 46 and 48, which are formed as components of brake assemblies 50 and 52, respectively. Opposed side walls 46 and 48 are attached to wall 44 by screws or the like and spool assembly 40 is mounted therebetween. It will be understood that various portions, such as side walls 46 and 48, can be formed as integral portions of structure 26. A short front wall 53, formed integrally with base wall 42, mounts pivot pins 24 and 25 and gears 29 and 30. Handle 22 is formed with a generally L-shaped member 54, including gear 27 with flat surface 37 attached thereto. L-shaped member 54 is fixedly embedded or keyed into handle 22 for movement therewith. Similarly, handle 23 is formed with a generally L-shaped member 56, including gear 28 with flat surface 38, embedded or keyed into handle 23 for movement therewith.

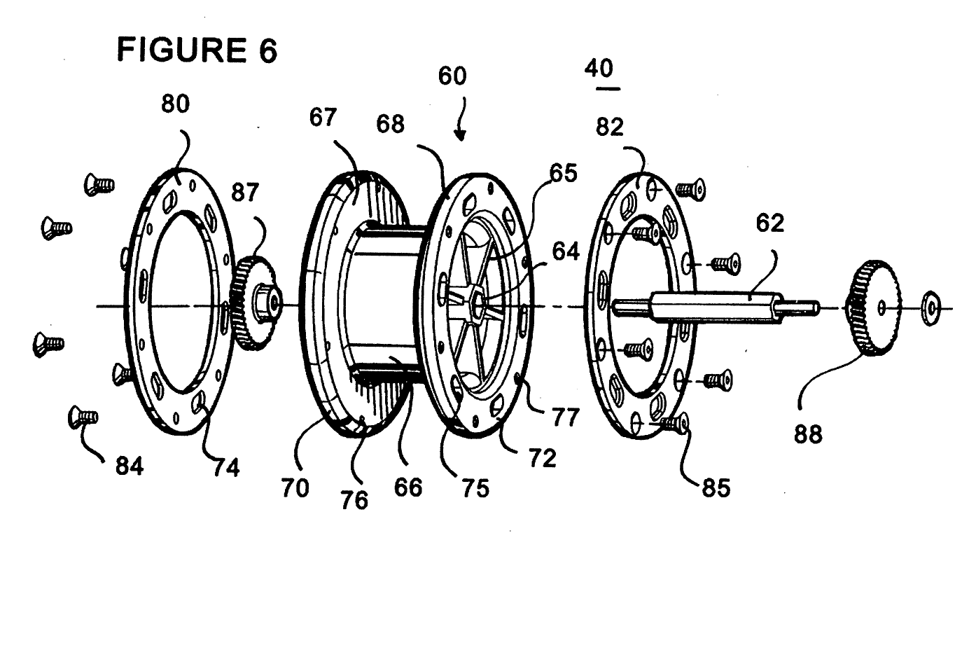

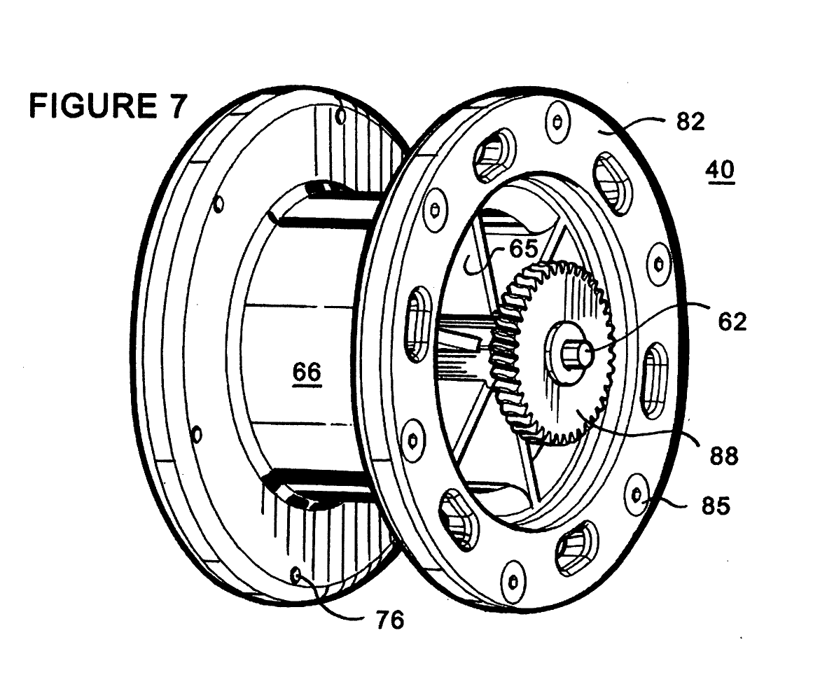

Turning to FIGS. 6 and 7, spool assembly 40 is illustrated in more detail. Spool assembly 40 includes an axle 62 with a polygonal cross-section (e.g. three, four, five, etc. sides). A spool 60 includes a mating cylindrical mounting hub 64 constructed to receive axle 62 non-rotatably positioned therein. A plurality of radially extending fins or spokes 65 fixedly attach and support a cylindrical body or line receiving drum 66 on mounting hub 64 for rotation therewith. Line receiving drum 66 is terminated at the ends in rims 67 and 68. In this preferred embodiment mounting hub 64, radiating spokes 65, drum 66, and at least a portion of rims 67, defining spool 60, are constructed integrally as a single piece, by some convenient means such as molding or the like. It will however, be understood by those skilled in the art that this assembly could be constructed in various convenient pieces and welded or otherwise affixed together. Generally, spool assembly 40 will be constructed of some ridged material, such as steel, aluminum, other metal, hard plastic, or some combination thereof. Also, the spoke embodiment is used to substantially reduce the overall weight of evacuation device 10.

Also, ring shaped members 70 and 72 are attached to rims 57 and 67, respectively, either by forming them integrally with rims 67 and 68 or by some convenient means such as welding, screws, etc. These are employed as strengthening members when a plastic spools is employed. The are not necessary if the spool is fabricated of a stronger material such as steel. Members 70 and 72 are formed with openings 74 and 75, respectively, spaced circumferentially therearound. Members 70 and 72 are also formed with internally threaded openings 76 and 77, respectively, spaced circumferentially therearound. A second pair of rings 80 and 82, with openings similar to the openings in members 70 and 72, is attached to members 70 and 72, respectively, for additional support by means of screws 84 and 85. A pair of gears 87 and 88 is fixedly attached to opposite ends of axle 62 for rotation therewith. While gears 87 and 88 are shown mounted on a smooth portion of axle 62, it will be understood that they can be keyed or splined to axle 62 or can have a polygonal opening and be mounted on the polygonal portion of axle 62. The extreme ends of axle 62 are smooth and free for insertion into bearings to be explained presently.

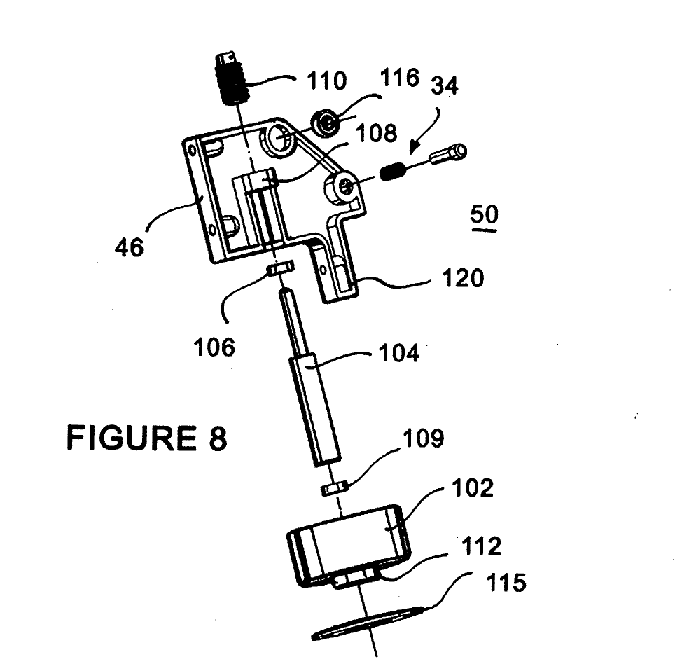

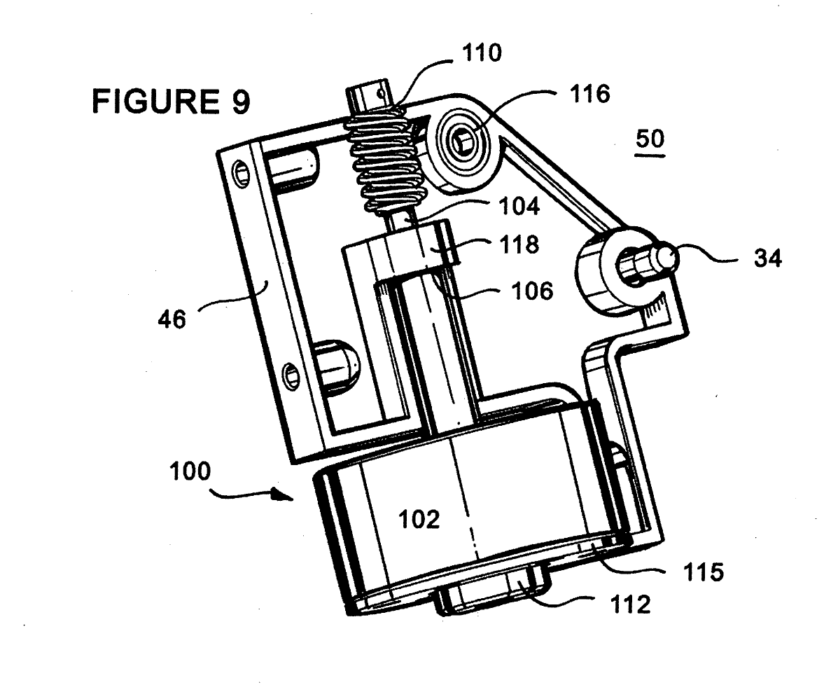

Turning now to FIGS. 8 and 9, brake assembly 50 is illustrated in detail. Here it should be understood that brake assemblies 50 and 52 are essentially similar, except that one is a mirror image of the other. Accordingly, only brake assembly 50 will be described in detail with the understanding that brake assembly 52 includes the same components. It will also be understood that a single brake assembly 50 can be employed. The dual brake system is preferred as a fail safe structure, due to the intended use of device 10. In this specific embodiment opposed side wall 46 of mounting structure 26 acts as a base for the mounting of a centrifugal brake 100. In a preferred embodiment centrifugal brake 100 includes a centrifugal clutch 102, such as that sold commercially by SUCO Inc. or a similar structure. Centrifugal clutch 102 includes flyweights positioned to overcome adjustable return springs when sufficient rotary speed (centrifugal force) is reached. A range of engagement speeds can be achieved through adjustments of the return springs. Because centrifugal clutches of the type described can be purchased commercially, further description of the inner construction will not be provided.

A driving shaft or axle 104 is coupled to centrifugal clutch 102 so as to rotate with the inner components of centrifugal clutch 102. Axle 104 is rotatably mounted onto the inner surface of opposed side wall 46 by means of an upper bearing 106 positioned in a bearing mounting structure 108. The lower end of axle 104 is held in place by means of a lower bearing 109 mounted within the lower end of centrifugal clutch 102 (see FIG. 8). The upper end (in FIGS. 8 and 9) of axle 104 has a worm gear 110 fixedly attached, by some convenient means such as a pin, a spline, etc. for rotation therewith. The lower end of centrifugal clutch 102 has a portion 112 with a reduced diameter and tapered so as to fit conveniently into an opening 114 in base wall 42 of mounting structure 26 (see FIG. 5) to firmly anchor the lower end of centrifugal clutch 102 in the correct alignment. A mounting plate 115 is included to receive screws or the like to fixedly hold portion 112 engaged in opening 114. The inner surface of opposed side wall 46 also fixedly mounts a bearing 116 positioned to receive and rotatably mount one end of axle 62 of spool assembly 40. Spring loaded locking pin 34 can also be seen positioned in an opening in opposed side wall 46 for horizontal movement.

Referring specifically to FIGS. 4 and 5, the assembly and inter-relationship of the components of emergency evacuation device 10 can be seen more clearly. With the end of axle 62 of spool assembly 40 rotatably engaged in bearing 116 of opposed side wall 46, worm gear 110 meshes with gear 87 fixedly engaged on the end of axle 62. Similarly, a worm gear in centrifugal brake assembly 52 engages with gear 88 fixedly engaged on the opposite end of axle 62 when the opposite end of axle 62 is engaged in a bearing in the inner surface of opposed end 48. Thus, both centrifugal brakes are geared to axle 62 of spool assembly 40 for rotation therewith. By gearing a centrifugal brake to axle 62 on each end, equal braking is applied to both ends and no undue stress occurs on any of the components. Further, the inclusion of dual brakes in emergency evacuation device 10 greatly improves the reliability and reduces the possibility of the failure of a single brake or other component. Here it will be understood that while a specific gearing arrangement (i.e., gears 87 and 88 and worm gears 110) are illustrated for explanation, other gear arrangements or rotary connections can be used if desired or convenient.

Spool 60 is constructed with a relatively large diameter so that rotation produces relatively high centrifugal force. This high or amplified centrifugal force allows for extremely accurate speed settings of the centrifugal brakes, through adjustments of the return springs in the centrifugal clutches. It will be understood by those skilled in the art that the speed settings provide a pre-set descent rate and the descent rate is the same for any user, regardless of the size or weight and even including rescue workers carrying rescued people. Thus, the person using emergency evacuation device 10 does not have to control the descent during the emergency but simply grips handles 22 and 23 in the extended position. Gripping handles 22 and 23 also gives the descending person something to hang onto so they will not inadvertently grasp the line and damage their hands. Providing the descending person with something to hang onto, psychologically acts to reduce panic and instill a feeling of safety.

With the ends of axle 62 of spool assembly 40 rotatably engaged in the bearings in opposed side walls 46 and 48, spring loaded locking pins 34 and 35 are positioned to each engage one of the openings 74 and 75, respectively, in ring shaped members 70 and 72 and the attached second pair of rings 80 and 82. Spring loaded locking pins 34 and 35 are spring loaded to be biased outwardly away from openings 74 and 75 but are forced into openings 74 and 75 when handles 22 and 23 are moved into the collapsed orientation (see FIG. 1). Providing a pair of spring loaded locking pins 34 and 35 on opposite sides of spool 60 reduces stress on spool 60, as well as other components, and improves the reliability of emergency evacuation device 10. Once handles 22 and 23 are moved outwardly to the extended orientation (see FIG. 4) the spring bias on locking pins 34 and 35 moves them into a disengaged position and spool 60 is free to rotate.

Opposed side walls 46 and 48 are each constructed with a downwardly extending tang 120 and 122, respectively, positioned to have mounted therein pivot pins 24 and 25, respectively, either instead of or in addition to being mounted on side 53 of mounting structure 26. Generally L-shaped members 54 and 56, including gears 27 and 28 are rotatably affixed on pivot pins 24 and 25 so that flat surfaces 37 and 38 of L-shaped members 54 and 56 engage spring loaded locking pins 34 and 35 in the collapsed orientation. Also, gears 27 and 28 mesh with gears 29 and 30 so that both handles 22 and 23 move together. Housing halves 14 and 15 cooperate to enclose the various moving parts and prevent foreign materials from entering and obstructing the operation.

In the operation of emergency evacuation device 10, when an emergency occurs a person attaches emergency evacuation device 10 to their body by means of harness 20. A free end of a length of high tensile strength line 125 (see FIG. 3) is attached to an anchor point, the remainder of line 125 being wound on spool 60. In a preferred embodiment, fishing line is used with device 10 due to its strength, and because it has a relatively small diameter allowing for the use of a compact spool while providing great length. Since an individual will not grasp line 125, it can be extremely thin. The length of the line can be sufficient to allow evacuation of the tallest buildings. The line can be as long as 2000 feet and have a tensile strength of 1500 pounds, although 500 lb test is preferred and shorter lengths can be used to accommodate any building. It should be understood that a variety of high tensile strength ropes, cables, lines, etc. (referred to as “lines”) could be used and the fishing line is just a preferred example.

Various types of line can be employed, some having great fire and cut resistance, while still being strong, light and being of small diameter. Fire and cut resistant lines can be produced from a wide range of products like: Kevlar® (Para Aramid—E.I. Dupont), Technora® (Para Aramid—Teijin), Twaron® (Para Aramid—Teijin), Nomex® (Meta Aramid—E.I. DuPont), TeijinConex (MetaAramid—Teijin), Zylon® (Poly P-Phenylene-2-6—Benzobisoxazole) (PBO) (Toyobo), Vectran® (Liquid Crystal Polymer—Celanese), PBI® (Polybenzimidazole—Celanese), and a few others. All of these fibers are good for flame resistance. Fibers that provide better heat protection are PBI® (Polybenzimidazole—Celanese) and Zylon® (Poly P-Phenylene-2-6—Benzobisoxazole) (PBO) (Toyobo). These fibers have almost twice the flame resistance as the first group. The best fiber for heat and strength is Zylon® (Poly P-Phenylene-2-6—Benzobisoxazole) (PBO) (Toyobo). This fiber is about 60% higher in strength along with increased heat resistance.

Any one of the following products can make a good, strong, cut resistant line: Kevlar® (Para Aramid—E.I. Dupont), Technora® (Para Aramid—Teijin), Twaron® (Para Aramid—Teijin), Zylon® (Poly P-Phenylene-2-6—Benzobisoxazole) (PBO) (Toyobo), and Vectran® (Liquid Crystal Polymer—Celanese). Better cut resistance is made by adding or blending steel fiber and/or glass with the fibers. Better abrasion resistance occurs when using Vectran® (Liquid Crystal Polymer—Celanese) or Zylon® (Poly P-Phenylene-2-6—Benzobisoxazole) (PBO) (Toyobo). A good heat, abrasion, and cut resistance combination is Vectran® (Liquid Crystal Polymer—Celanese) and steel or glass.

The preferred cord made without steel and/or glass blended with the fiber is Zylon® (Poly P-Phenylene-2-6—Benzobisoxazole) (PBO) (Toyobo). This has the highest strength, heat resistance, and cut resistance physical properties. The best cord for shock and heat resistance is Technora® (Para Aramid—Teijin). The best general use cord for shock resistance, heat resistance, strength, and cut resistance should be made from 75% Technora® (Para Aramid—Teijin) with 25% Zylon® (Poly P-Phenylene-2-6—Benzobisoxazole) (PBO) (Toyobo). This cord is covered at critical areas with a blend of 84% Vectran® (Liquid Crystal Polymer—Celanese) and 16% steel (0.0015 to 0.0040 inches) monofilament for cut, abrasion, and heat resistance. The preferred thread to sew the cord and jacket together would be Kevlar® (Para Aramid—E.I. Dupont), Technora® (Para Aramid—Teijin), Twaron® (Para Aramid—Teijin), or Vectran® (Liquid Crystal Polymer—Celanese) thread.

With line 125 securely anchored, the person steps to a window or the roof and moves handles 22 and 23 to the extended orientation. The person, regardless of their weight or size, will be lowered at a predetermined rate as they grip handles 22 and 23. Because axle 62, on which spool 60 is mounted, has a substantially equal braking torque on both ends there is no danger of unequal stress warping components and jamming the rotation. Further, if the person reaches a lower floor or other place of safety, they can move handles 22 and 23 into the collapsed orientation and safely and easily stop their descent.

Thus, a new and improved dual brake emergency evacuation device (can be a single brake device) with lock releasing handles is disclosed. The dual brake emergency evacuation device with lock releasing handles can be used in all structures of any height and from any floor or level. Also, the dual brake emergency evacuation device with lock releasing handles is simple to use and is compact and lightweight and extremely safe and/or reliable to use. The dual brake emergency evacuation device with lock releasing handles requires little or no operation by the individual and does not require physical strength or specialized skills. Because of the dual centrifugal brakes, little or no horizontal stresses are placed on the device so that unwinding of the line can be a result of a nearly pure vertical force, which substantially improves the descent and improves the reliability and safety.

Various changes and modifications to the embodiments herein chosen for purposes of illustration will readily occur to those skilled in the art. For example, the various gear arrangements can be modified by including more or less gears and by using different gears. With the provision of dual handles, the likelihood of an individual gripping the line or otherwise panicking is substantially reduced. To the extent that such modifications and variations do not depart from the spirit of the invention, they are intended to be included within the scope thereof.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. An emergency evacuation device for lowering an individual comprising:
a housing including a mounting structure;
a spool assembly mounted on the mounting structure within the housing, the spool assembly including a rotatably mounted spool designed to receive a length of high tensile strength line;
a centrifugal brake coupled to the spool for rotation with the spool;
a locking device carried by the housing and moveable between a spool locking position wherein the locking device engages the spool and a spool unlocking position; and
two-hand releasing handle apparatus positioned adjacent locking device and mounted so as to selectively provide movement of the locking device into one of the spool locking position and the spool unlocking position.

2. An evacuation device as claimed in claim 1 wherein the spool is mounted on an axle for rotation with the axle, the spool assembly includes first gears attached adjacent opposite ends of the axle for rotation with the axle and the spool, and the centrifugal brake is coupled to the axle by second gears that mesh with the first gears.

3. An evacuation device as claimed in claim 2 wherein the spool includes a line receiving drum spaced coaxially from the axle by radially extending spokes, the drum having a substantially larger diameter than the axle.

4. An evacuation device as claimed in claim 2 wherein one of the first gears and the second gears includes worm gears.

5. An evacuation device as claimed in claim 1 wherein the centrifugal brake includes a centrifugal clutch constructed to maintain a speed of descent at a predetermined speed.

6. An evacuation device as claimed in claim 5 wherein the centrifugal brake includes an adjustment for setting engagement speed of the centrifugal brake.

7. An evacuation device as claimed in claim 1 wherein the locking device includes at least one locking pin positioned adjacent a side of the spool and engages the spool in the spool locking position in which the spool is prevented from rotating and is disengaged from the spool in the spool unlocked position in which the spool is free to rotate.

8. An evacuation device as claimed in claim 7 wherein the at least one locking pin includes a pair of locking pins, one each positioned adjacent opposite sides of the spool and each having a spool locking position in which the spool is prevented from rotating and a spool unlocked position in which the spool is free to rotate.

9. An evacuation device as claimed in claim 8 wherein the two-hand releasing handle apparatus includes a pair of opposed handles pivotally mounted for movement into one of a collapsed orientation and an extended orientation.

10. An evacuation device as claimed in claim 9 wherein the pair of opposed handles pivotally mounted for movement into one of a collapsed orientation and an extended orientation are coupled together for simultaneous movement.

11. An evacuation device as claimed in claim 8 wherein the pair of opposed handles is further positioned to engage the pair of locking pins and move the pair of locking pins into the locking position when the pair of opposed handles is moved into the collapsed orientation.

12. An evacuation device as claimed in claim 11 wherein each of the pair of locking pins is spring biased into the unlocked position when the pair of opposed handles is moved into the extended orientation.

13. An emergency evacuation device for lowering an individual comprising:
a housing including a mounting structure;
a spool assembly mounted on the mounting structure within the housing, the spool assembly including a rotatably mounted spool designed to receive a length of high tensile strength line;
a centrifugal brake coupled to the spool for rotation with the spool; and
a pair of opposed handles rotatably mounted for movement into one of a collapsed orientation and an extended orientation.

14. An emergency evacuation device as claimed in claim 13 further including a locking device carried by the housing and moveable between a spool locking position wherein the locking device engages the spool and a spool unlocking position, and the pair of opposed handles being positioned to engage the locking device and move the locking device into the locking position when the pair of opposed handles is moved into the collapsed orientation and further positioned to disengage the locking device when the pair of opposed handles is moved into the extended orientation.

15. An evacuation device as claimed in claim 14 wherein the locking device includes at least one locking pin positioned adjacent a side of the spool and engages the spool in the spool locking position in which the spool is prevented from rotating and is disengaged from the spool in the spool unlocked position in which the spool is free to rotate.

16. An evacuation device as claimed in claim 15 wherein the at least one locking pin includes a pair of locking pins, one each positioned adjacent opposite sides of the spool and each having a spool locking position in which the spool is prevented from rotating and a spool unlocked position in which the spool is free to rotate.

17. An emergency evacuation device as claimed in claim 13 wherein the centrifugal brake is coupled to the spool at one side of the spool for rotation with the spool and the evacuation device further includes a second centrifugal brake coupled to the spool at an opposite side of the spool for rotation with the spool and constructed to maintain the rotation speed of the spool at the predetermined speed.

18. An emergency evacuation device for lowering an individual comprising:
a housing including a mounting structure;
a spool assembly mounted on the mounting structure within the housing, the spool assembly including a rotatably mounted spool designed to receive a length of high tensile strength line;
a first centrifugal brake coupled to the spool at one side of the spool for rotation with the spool and constructed to maintain a rotation speed of the spool at a predetermined speed;
a second centrifugal brake coupled to the spool at an opposite side of the spool for rotation with the spool and constructed to maintain the rotation speed of the spool at the predetermined speed;
a pair of locking pins one each positioned adjacent opposite sides of the spool and each having a spool locking position in which the spool is prevented from rotating and a spool unlocked position in which the spool is free to rotate, and each of the pair of locking pins being spring biased into the unlocked position; and
a pair of opposed handles rotatably mounted for movement into one of a collapsed orientation and an extended orientation, the pair of opposed handles being positioned to engage the pair of locking pins and move the pair of locking pins into the locking position when the pair of opposed handles is moved into the collapsed orientation and further positioned to disengage the pair of locking pins when the pair of opposed handles is moved into the extended orientation.

19. An evacuation device as claimed in claim 18 wherein the spool is mounted on an axle for rotation with the axle, the spool assembly includes first gears attached adjacent opposite ends of the axle for rotation with the axle and the spool, and the first and second centrifugal brakes are each coupled to the axle by second gears that mesh with the first gears.

20. An evacuation device as claimed in claim 19 wherein the spool includes a line receiving drum spaced coaxially from the axle by radially extending spokes, the drum having a substantially larger diameter than the axle.

21. An evacuation device as claimed in claim 19 wherein one of the first gears and the second gears includes worm gears.

22. An evacuation device as claimed in claim 18 wherein each of the first and second centrifugal brakes includes an adjustment for setting engagement speed of each of the first and second centrifugal brakes.
